(19) United States
(12) Patent Application Publication
(10) Pub. No.: US 2007/0251300 A1
(43) Pub. Date: Nov. 1, 2007

(54) Device for Controlling and Regulating the Physical-Biochemical Condition of a Liquid Mixture

(76) Inventor: Bo Danielsson, Kalmar (SE)

Correspondence Address: DICKSTEIN SHAPIRO LLP, 1825 EYE STREET NW, Washington, DC, 20006-5403, US

(21) Appl. No.: 11/597,429

(22) PCT Filed: May 23, 2005
(86) PCT No.: PCT/SE05/00763

§ 371 Date: Mar. 2, 2007

(30) Foreign Application Priority Data
May 26, 2004 (SE) 0401336-3

(51) Int. Cl. B01L 11/00

(52) U.S. Cl. 73/53.01

(57) ABSTRACT

The present invention refers to a device for controlling and regulating the physical-biochemical condition of a liquid mixture (1) in a process in at least one container (3), e.g. a plastic bag (4), which is provided at a mixing means (5) on at least one mixing table (2), where said liquid mixture (1) is mixed by tilting of said mixing table (2). Sensors (8) are provided in said liquid mixture (1), which notice the physical-biochemical condition in the liquid mixture (1), which is registered in the form of measured measurement test results (9) in a computer/processor (7), in which they are compared with desired, predetermined determined measurement test results (10). A deviation (20) compared with the measured test results (9) is registered and activates a supply of different substances (6) to said liquid mixture (1), whereby the tilting speed (12) and tilting angle (14) of the mixing table (2) are adapted, so that the physical-biochemical condition in the liquid mixture (1) reaches the desired, predetermined, determined measurement test results (10).

The present invention refers to a device for controlling and regulating the physical-biochemical condition of a liquid mixture in a process in at least one container, e.g. a plastic bag, which is provided at a mixing means on at least one mixing table, where said liquid mixture is mixed by tilting of said mixing table. Sensors are provided in said liquid mixture, which notice the physical-biochemical condition in the liquid mixture, which is registered in the form of measured measurement test results in a computer/processor, in which they are compared with desired, predetermined determined measurement test results. A deviation compared with the measured test results is registered and activates a supply of different substances to said liquid mixture, whereby the tilting speed and tilting angle of the mixing table are adapted, so that the physical-biochemical condition in the liquid mixture reaches the desired, predetermined, determined measurement test results.

On the market there are today structures of this kind having different mixture equipments, so called mixing aggregates adapted to provide in a process desired liquid mixtures, such for example different cell cultures and so on. In said mixing aggregates there are different types of agitators and different feed connections for supplying different substances. Different sensors are connected to said liquid mixture in order to manually read off measured values at the right times on different displays and measurement equipments. The measured values give information about which substance and in which quantity and at what time said substance shall be added in order to provide the right and desired liquid mixture. This occurs anyhow manually. The mixture process is also performed manually, whereby the speed of the agitator, the starting time and during how long time it shall function is done manually. This process is expensive, personal required and time consuming and requires much careful, lengthy and permanent care. If a mistake occurs a very expensive liquid mixture get lost. Then this liquid mixture must be discarded and the process be performed once again during high material- and working costs and because of this further time get lost. Further on a ready liquid mixture can also during a validation comprise a too bad quality, and because of that be lost. To make a mixture in mixing aggregates having built in agitators furthermore also require an expensive and time consuming cleaning process, which always does not will be enough effective.

One object of the present invention is to eliminate the drawbacks existing with the previously known structures by guiding the physical-biochemical condition in the container in the form of measured measurement test results in a computer/processor, which therein are compared to desired, predetermined, determined measurement test results and which activate a supply of different substances to said liquid mixture and the tilting speed of the mixing table, tilting angle, so that the physical-biochemical condition in said liquid mixture reaches the desired, predetermined, determined measurement test results.

Thanks to the invention a device for automatic controlling and regulating the physical-biochemical condition of a liquid mixture in a process in at least one container in the form of a plastic bag, which is provided on a mixing table at a mixing means, where said liquid mixture is mixed by tilting of said mixing table by aid of a driving means. The liquid mixture consists of e.g. a cell culture, blood, blood plasma, nutrient solution, medicine mixtures, perfumes, foodstuffs, such as e.g. juice, sauces, spices, and so on. In or in connection to said liquid mixture sensors are provided, which notice the physical-biochemical condition in the liquid mixture with respect to i.e. temperature, percentage of oxygen, percentage of carbon dioxide, cell amount, turbidity, viscosity, conductivity, PH-value and so on. The sensors notice the physical-biochemical condition in the form of measured measurement test results, which are registered of a computer/processor. These results being compared with desired, determined measurement test results available in the computer/processor, which are compared with the measured measurement test results. This information is processed in the computer/processor and is the basis for activating a delivery of different, desired substances to the liquid mixture such as oxygen, carbon dioxide, nutrient solution, air, chemicals or the like. This occurs in this case at a desired time and in a desired amount via a feed connection to said liquid mixture. In a corresponding extent the driving means is activated to increase or decrease the tilting speed or tilting angle of said mixing table at a desired time and during a desired time period, whereby an adaption occurs of the physical-biochemical condition in the liquid mixture to the desired predetermined, determined measurement test results. At a preferred embodiment example of the invention the liquid mixture circulates up to and from the container in a circulation connection, to which a circulation container is connected. In this case the sensors are in or near the container, in the circulation connection or in the circulation container, to give an information so exact as possible about the physical-biochemical condition. It is important that the temperature in the liquid mixture is kept at an exact value. Therefore the mixing table is provided with a heatable and/or cooling device, which is temperature guided with a temperature sensor, which regulates the temperature of the liquid mixture to the desired, predetermined, determined measurement test result. The tilting speed can be adapted to the cell amount in the liquid mixture, whereby the conductivity is registered electrically of the sensor. The turbidity, i.e. the muddiness is controlled in the liquid mixture, whereby the light coming through of ultra red light is measured by a sensor. During too high, measured values the tilting speed or tilting angle is increased. The driving means used consists of a frequency guided electric motor provided with a at least one frequency converter or an air driven air cylinder motor for adaption of the tilting speed or tilting angle. The mixing means has a base portion, in which the driving means is provided. The mixing table is movably provided in said base portion via a suspension means in the form of a joint, axis, turning point, hinge function or the like. Thus, the most important features of the invention are that you can automatically control both the desired supply of substances to the liquid mixture and also the desired regulation of the tilting speed and tilting angle of the mixing table without having a permanent control of the process. This lowers the costs and increases the safety of operation, which gives very great economical and time saving profits.

The invention is described closer below by aid of a preferable embodiment example in view of the drawings enclosed, in which

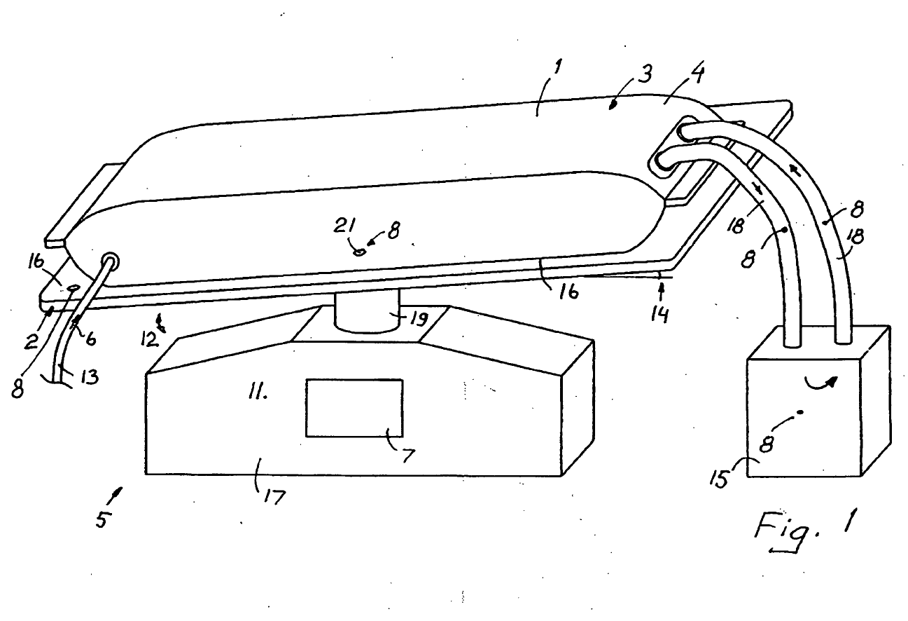

FIG. 1 shows a perspective view of the mixing means, and

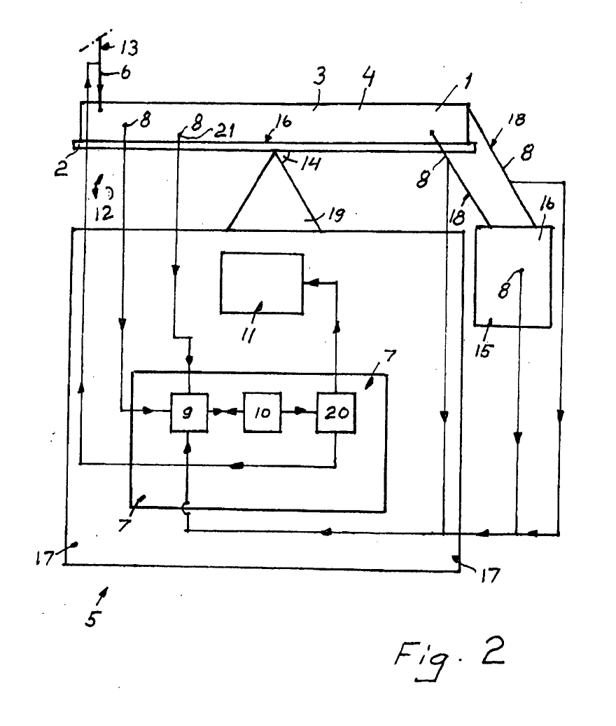

FIG. 2 shows a schematic flow diagram over the built-up of the process.

As can be seen from the figures FIG. 1 and 2 illustrate a device for controlling and regulating the physical-biochemical condition of a liquid mixture in a process. A mixing means 5 is provided with a base portion 17 having a driving means 11 and a mixing table 2, which is provided in said base portion 17 via a suspension means 19. A container 3 such as a plastic bag 4 is provided on the mixing table 2 having sensors 8, which register measured measurement test results 9 in a computer/processor 7. According to FIG. 2 a flow diagram illustrates that the measured results 9 are compared with desired, predetermined, determined measurement test results 10, whereby a deviation 20, compared with the measured results 9 is registered in the computer/processor 7. The deviation 20 is given as an information to the computer/processor 7, which activates a supply of the different desired substances 6 in a corresponding extent to the liquid mixture 1 via a feeding connection 13 and activates the driving means 11 correspondingly to increase or decrease the tilting speed 12 and/or tilting angle 14 of the mixing table 2. The container 3 comprises a circulation connection 18 to a circulation container 15 having these sensors 8. The mixing table is provided with a heatable or cooling means 16 and a connected sensor 8 in the form of a temperature sensor 21.

1. A device for controlling and regulating the physical-biochemical condition of a liquid mixture (1) in a process in at least one container (3), preferably a plastic bag (4) which is provided at a mixing means (5) on at least one mixing table (2), where said liquid mixture (1) is mixed by tilting of said mixing table (2) by aid of at least one driving means (11), characterized in that in and/or in connection to said liquid mixture (1) at least one sensor (8) is provided, which notices the physical-biochemical condition with respect to i.e. temperature, percentage of oxygen, percentage of carbon dioxide, cell amount, turbidity, viscosity, conductivity, PH-value and so on, by registering the said physical-biochemical condition in the form of measured measurement test results (9) in a computer/processor (7), these results being compared with desired, determined measurement test results (10) available in the computer/processor (7) and a deviation (20) compared with the measured measurement test results (9) is registered in the computer/processor (7), said deviation (20) is given as information to the computer/processor (7), which activates a delivery of at least one of different, desired substances (6) to the liquid mixture (1) correspondingly and/or activates the driving means (11) correspondingly to increase or decrease the tilting speed (12) and/or tilting angle of the mixing table (2), whereby an adaption is going on of the physical-biochemical condition in the liquid mixture (1) to the desired, predetermined measurement test results (10).

2. A device according to claim 1, characterized in that the liquid mixture (1) is connected to at least one feed connection (13), which supplies the desired substances (6) to said liquid mixture (1) to achieve desired, predetermined, determined measurement test results (10).

3. A device according to claim 1, characterized in that the liquid mixture (1) circulates to and from said container (3) in at least one circulation connection (18), to which at least circulation container (15) is connected, so that at least one sensor (8) is provided to register the measured measurement test results (9) in at least one the following places such as in said container (3), in the circulation connection (18).

4. A device according to claim 1, characterized in that the liquid mixture (1) consists of e. g. a cell cultivation, blood, blood plasma, nutrient solution, medicine mixtures, perfumes, foodstuffs, such as e. g. juice, sauces, spices, and so on and that the substances (6) desired consist of e.g. oxygen, carbon dioxide, nutrient solution, air, chemicals and the like.

5. A device according to claim 1, characterized in that the mixing table (2) comprises at least one warm up and/or cool down device (16), which can warm up/cool down said liquid mixture (1) to the desired, predetermined, determined measurement test result (10).

6. A device according to claim 1, characterized in that the tilting speed (12) is adapted to the cell quantity in the liquid mixture (1), whereby the conductivity is registered electrically of the sensor (8).

7. A device according to claim 1, characterized in that the turbidity, i.e. the muddiness is controlled in the liquid mixture (1), whereby the light transmission of infrared light is measured by the sensor (8) for the registration of the measurement test results (9), so that the tilting speed (12) and/or the tilting angle (14) is increased/decreased.

8. A device according to claim 1, characterized in that the driving means (11) consists of at least one frequency controlled electric motor, equipped with at least one frequency converter and/or of at least one air driven air cylinder motor for timing of the tilting speed (12) and/or the tilting angle (14).

9. A device according to claim 1, characterized in that the mixing means (5) comprises a base portion (17), in which said driving means (11) is provided and that the mixing table (2) is movably provided in said base portion (17) via at least one suspension means (19) in the form of at least one link, axis, turn point, hinge function, or the like.

10. A device according to claim 1, characterized in that the supply of the different desired substances (6) is done in a desired quantity and at a desired point of time or that the driving means (11) is activated at the right moment and during the desired period of time with desired tilting speed (12) or tilting angle (14), whereby an adaptation is done of the physical-biochemical condition in the liquid mixture (1) to the desired, predetermined, determined measurement test results (10) within a desired period of time.
